(19) United States
(12) Patent Application Publication
(10) Pub. No.: US 2006/0181207 A1
(43) Pub. Date: Aug. 17, 2006

(54) Electric incandescent lamp with infrared reflecting layer

(75) Inventor: Wilhelmus Cornelis Maria Claassen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/549,560

(22) PCT Filed: Mar. 17, 2004
(86) PCT No.: PCT/IB04/50275

§ 371 Date: Sep. 19, 2005

(30) Foreign Application Priority Data
Mar. 20, 2003 (EP) 03100717.2

(51) Int. Cl. H01K 1/50

(52) U.S. Cl. 313/579

(57) ABSTRACT

An electric incandescent lamp comprising a light-transmitting envelope (2) provided with an infrared-reflecting layer, the envelope (2) having a longitudinal axis (1). The lamp furthermore comprises a luminous member (5) having two substantial parallel portions (6) that are positioned substantially parallel to said longitudinal axis (1). In a sectional view perpendicular to said longitudinal axis (1), said envelope (2) has substantially an elliptical shape with said two portions (6) of the luminous member (5) in respective focal points of said elliptical shape.

The invention relates to an electric incandescent lamp, in particular to an electric incandescent halogen lamp comprising a light-transmitting envelope or bulb provided with an infrared-reflecting layer, the envelope having a longitudinal axis, the lamp furthermore comprising a luminous member having two substantially parallel portions that are positioned substantially parallel to said longitudinal axis.

U.S. Pat. No. 5,811,934 describes an electric incandescent lamp. The shape of the envelope thereof is designed such that the infrared radiation emitted by the luminous member, is reflected back in the direction of that luminous member again.

The infrared-reflecting layer, also called infrared radiation reflecting coating, may be present at the inner surface and/or at the outer surface of the envelope surrounding the luminous member, or it may be present at a part of that envelope. The infrared-reflecting layer has the effect that at least a portion of the infrared radiation produced by the luminous member is reflected back into the envelope. The result is an increased lamp efficacy that can be used to increase the temperature of the luminous member and consequently the luminous flux for a constant electrical power consumption. On the other hand, a given luminous flux can be attained with less electrical power consumption, providing an advantageous energy-saving effect. Another effect that is sometimes desired is that less infrared radiation power is emitted through the envelope, resulting in less heating of the environment.

An effective reflection of the infrared radiation is achieved when the reflected radiation is directed back to the surface of the luminous member. The shape of the portion of the envelope carrying the reflective layer should be adapted to the location of the luminous member inside the envelope in order to achieve this.

The object of the invention is to provide an effective reflection in an electric incandescent lamp comprising a light-transmitting envelope containing a luminous member having two parallel portions at a distance from each other.

To accomplish this object, said envelope has, in a sectional view perpendicular to said longitudinal axis, substantially an elliptical shape with said two portions of the luminous member in the two focal points of said elliptical shape. The part of the envelope having the elliptical shape and the parallel portions of the luminous member may extend over an certain distance, so that said part of the envelope has the shape of a tube having an elliptical cross-section, whereby both portions of the luminous member are positioned in the two focal lines within that tube. The infrared radiation emitted by one of said portions of the luminous member will thus be reflected by the reflecting layer on the tubular envelope to the other portion of the luminous member.

In one preferred embodiment, the electric incandescent lamp is a halogen lamp.

Preferably, the luminous member is substantially U-shaped, such that the two limbs of the U-shape are positioned parallel to said longitudinal axis and constitute said two parallel portions of the luminous member. The ends of said limbs can then be connected to external electrical contacts, which electrical contacts extend outside the envelope at one side of the lamp.

In the case of a U-shaped luminous member, the base portion thereof may be supported by a support element, which support element may be fixed at the side of the envelope where the electrical contacts are located.

In one preferred embodiment, the luminous member is a coiled filament, i.e. a filament wound in a helical shape. The filament forming the luminous member can thus be made much longer than the luminous member itself, so that a higher voltage can be applied to the luminous member. To achieve a longer filament, the luminous member may be a coiled-coil filament, i.e. a coiled filament (helically shaped filament) is coiled once again into a helical shape having a greater diameter than the former helical shape.

In one preferred embodiment, there are two envelopes, an inner envelope and an outer envelope, one of the envelopes being provided with the infrared-reflecting layer and having said elliptical shape. Preferably, the outer envelope is provided with the infrared-reflecting layer.

Preferably, the infrared-reflecting layer is applied to the inner wall of the envelope.

The invention will now be explained with reference to two embodiments of an electric incandescent halogen lamp and to a drawing, in which:

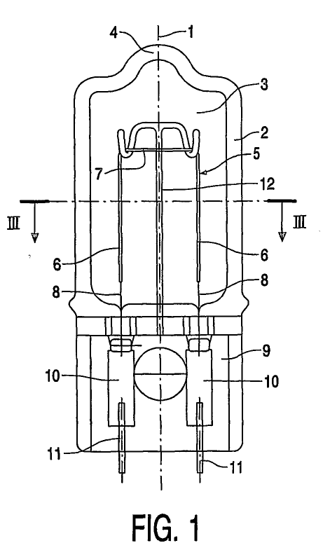

FIG. 1 is a front elevation of the lamp;

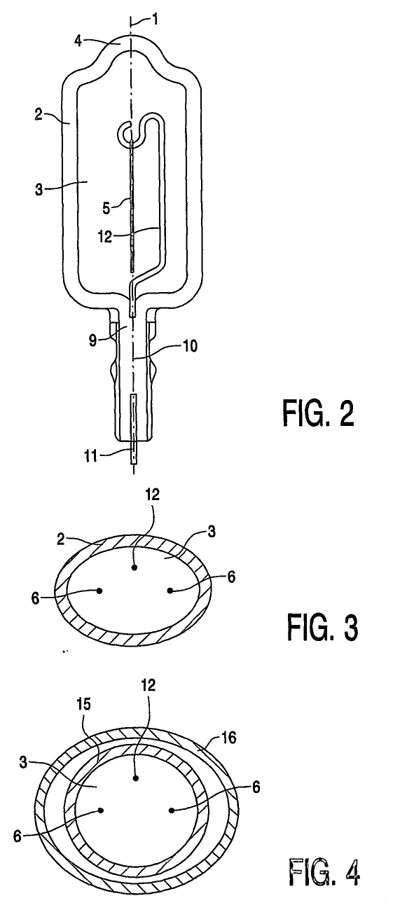

FIG. 2 is a side elevation of the lamp;

FIG. 3 is a sectional view taken on the line III-III in FIG. 1; and

FIG. 4 shows the second embodiment.

The Figures are schematic representations of the embodiments. The electric incandescent halogen lamp as shown in FIGS. 1 and 2 is a lamp for general lighting purposes, which is suitable for direct connection to a 220 V mains. The longitudinal axis of the lamp is indicated with line 1. The transverse dimension of the lamp may be between 10 mm and 15 mm, and the overall length of the lamp may be approximately 45 mm.

The lamp has an envelope 2 made of transparent material such as quartz glass. The inner space 3 of the envelope 2 is filled with in a known manner with an inert gas mixture, which is known per se, containing a conventional halogen additive. After the lamp has been assembled, the space 3 inside the envelope 2 is filled through a so-called exhaust tube 4 at the top of the envelope 2, which exhaust tube 4 is closed as its tip afterwards.

A luminous member 5 is located inside the envelope 2. The luminous member 5 has a U-shape with two parallel limbs 6, parallel to the axis 1 of the lamp, and a base portion 7. Apart from the ends of the two limbs 6, the luminous member is formed by a coiled-coil filament, i.e. a coiled filament (helically shaped filament) is coiled once again into a helical shape having a greater diameter than the former helical shape.

The ends of the two limbs 6 serve as electrical power supply leads 8 and extend in the pinch 9, which is a seal closing the envelope 2 hermetically at the lower side of the lamp. Said power supply leads 8 are connected to the ends of sealing foils 10 embedded in pinch 9. The other ends of sealing foils 10 are connected to contact pins 11 which are partly embedded in pinch 9 and partly project outside pinch 9. Electrical power can be supplied to the luminous member of the lamp through said contact pins 11, said sealing foils 10, and said leads 11, which is known per se in electric incandescent halogen lamps.

The space 3 in the envelope 2 furthermore comprises a support element 12, which is fixed in the pinch 9 at its lower end and supports the base 7 of the luminous member 5 at its other end, so that luminous member 5 is maintained in its U-shaped position as is shown in FIG. 1.

The luminous member 5 emits light radiation as well as infrared radiation. The purpose of the lamp is the radiation of light, and the infrared radiation is an unwanted effect. To reduce the infrared radiation of the lamp, the inner wall of envelope 2 is coated with an infrared radiation reflecting layer, so that the infrared radiation is, at least partly, kept inside the envelope 2. It is advantageous for this purpose to direct the reflected infrared radiation towards the luminous member 5, so that said radiation will supply additional heat to the luminous member 5.

To direct the infrared radiation of each of the limbs 6 of the luminous member to the other limb 6, the shape of the envelope 2, in a sectional view perpendicular to longitudinal axis 1, is elliptical. Said elliptical shape is shown in FIG. 3, where the two limbs 6 of the luminous member 5 are positioned in the focal points of the elliptical shape. This configuration of the envelope 2 and the limbs 6 has the effect that the infrared radiation of each of the limbs 6 is directed to the other limb 6 over a major portion of the light emitting part of the lamp, resulting in a more efficient lamp.

FIG. 4 is a sectional view of another embodiment of an electric incandescent lamp, where two transparent envelopes are present, an inner envelope 15 and an outer envelope 16. The outer envelope 16 is coated at its inner side with an infrared-reflecting layer. Since the outer envelope 16 has an elliptical shape with the two limbs 6 of the luminous member 5 in the two focal points, the infrared radiation of one limb 6 will be directed to the other limb 6. The inner envelope 15 may have an alternative shape, for example a circular sectional shape as shown in FIG. 4.

The application of a second envelope may be advantageous if a usual lamp is to have an increased efficiency, in which case said lamp is surrounded by the elliptical second envelope having an infrared-reflecting layer, but the invention may also be applied in lamps having two envelopes around each other for other reasons.

The described embodiments of the electric incandescent lamp are merely examples; a great many other embodiments are possible.

1. An electric incandescent lamp comprising a light-transmitting envelope provided with an infrared-reflecting layer, the envelope having a longitudinal axis, the lamp furthermore comprising a luminous member having two substantially parallel portions that are positioned substantially parallel to said longitudinal axis, characterized in that, in a sectional view perpendicular to said longitudinal axis, said envelope has substantially an elliptical shape with said two portions of the luminous member in respective focal points of said elliptical shape.

2. A lamp as claimed in claim 1, characterized in that the lamp is an electric incandescent halogen lamp.

3. A lamp as claimed in claim 1, characterized in that the luminous member is substantially U-shaped, and both limbs of the U-shape are positioned parallel to said longitudinal axis.

4. A lamp as claimed in claim 3, characterized in that the ends of said limbs are connected to external electrical contacts.

5. A lamp as claimed in claim 3, characterized in that the base of the U-shaped luminous member is supported by a support element.

6. A lamp as claimed in claim 1, characterized in that the luminous member is a coiled filament.

7. A lamp as claimed in claim 1, characterized in that the luminous member is a coiled-coil filament.

8. A lamp as claimed in claim 1, characterized by two envelopes, an inner envelope and an outer envelope, one of the envelopes being provided with the infrared-reflecting layer and having said elliptical shape.

9. A lamp as claimed in claim 8, characterized in that the outer envelope is provided with the infrared-reflecting layer.

10. A lamp as claimed in claim 1, characterized in that the infrared-reflecting layer is applied to the inner wall of the envelope.
